(19) United States
(12) Patent Application Publication
(10) Pub. No.: US 2008/0071886 A1
(43) Pub. Date: Mar. 20, 2008

(54) METHOD AND SYSTEM FOR INTERNET SEARCH

(76) Inventors: Wesley Scott Ashton, Lorton, VA (US); Rama Roberts, San Mateo, CA (US); Roy Roberts, Washington, DC (US)

Correspondence Address: GRIFFIN & SZIPL, PC, SUITE PH-1, 2300 NINTH STREET, SOUTH, ARLINGTON, VA, 22204, US

(21) Appl. No.: 11/618,289

(22) Filed: Dec. 29, 2006

(51) Int. Cl. G06F 17/30; G06F 15/16

(52) U.S. Cl. 709/219; 707/3; 709/217

(57) ABSTRACT

This invention relates to a method and system of operating an internet search engine with particular regard to granting permission to reproduce content from a web site. Also disclosed is a system for obtaining authority to copy content from a website accessible on an internet, as well as a method of granting permission for copying and reproduction of content from a website, and methods for licensing copying and reproduction.

### FIELD OF THE INVENTION

The invention relates to a method and system of operating an internet search engine with particular regard to seeking authorization to copy and subsequently reproduce content from a web site.

### BACKGROUND OF THE INVENTION

Internet search engines, such as google.com and others, serve a valuable function by collecting data accessible throughout the internet and presenting the data in a form available for convenient search by the public. Frequently, in order to make search results more useful, internet search engines [hereinafter “search engines”] present cached excerpts of content in their search results. These reproduced excerpts can frequently consist of text surrounding the search term and/or thumbnail images. Moreover, other services copy large portions or the entireties of web sites for archival purposes—these can also be regarded as a form of search engine.

Underlying data for search engines frequently comes from programs known as “web crawlers” or “spiders” [hereinafter “web crawlers”]. Web crawlers access websites on the internet, an can be directed to search for specific content as desired by their operators, as well as to include or exclude certain content.

The operator of a website, by editing a file named robots.txt, can exclude specific search engines from searching (or “crawling”) the website, and can exclude specific directories from search as well. (See W3C Recommendation, Appendix B, Section 4)

However, the protocol of the robots.txt file does not permit control of what content search engines may reproduce in their search results, and the ways in which the content may be reproduced. While many website operators prefer having search engines trawl their websites, in some cases they do not wish their content reproduced in search results.

Difficulties arise in balancing the desires and the rights of the search engine and web crawler operators, website operators, and the public, particularly with regard to copyright. For example, copying content from a website can be seen as a violation of copyright, particularly when some content is later reproduced in search results. Although a defense of fair use is sometimes raised, there is no “bright line” test for fair use, so it is very difficult to ascertain whether the use is actually fair. Thus, issues of copyright authority and possible infringement remain uncertain and problematic under existing technologies. The present invention aims to solve this problem.

### SUMMARY OF THE INVENTION

This invention aims to overcome the problem of search engine republication of website content without clear permission from the website operator.

An illustrative embodiment of the invention includes the steps of using a global computer network (i.e., the internet) to identify content on a website and one or more flags associated with the content. Each flag has information providing an authority level for copying and subsequent reproduction of a portion or all of the associated content. Preferably, the flags and content are accessed via HTTP.

Another illustrative embodiment includes the step of transmitting copied content to a search engine database.

In yet another illustrative embodiment, the “using” step includes searching performed by a web crawler of a search engine, wherein the search engine comprises the web crawler and the search engine database.

In still another illustrative embodiment, the content includes one or more items selected from the group consisting of text file data, image file data, video file data, and audio file data. Examples of each of these types of content are provided below. Preferably, the authority level distinguishes between two or more types of content.

In yet another illustrative embodiment, a plurality of users can set the authority levels of the one or more flags.

In still another illustrative embodiment, the authority levels distinguish between a plurality of search engines.

Another illustrative embodiment of the invention is a system for obtaining authority to copy content from a website, including one or more websites having content and flags, a database connected to receive transmissions, and a web crawler configured to search the one or more computer servers to identify the one or more flags, wherein when the web crawler identifies one or more of the flags, the web crawler copies content associated with the identified flag and sends the copied content to the first database via the internet, and the first database stores the copied content. The content may include text file data, image file data, video file data, and audio file data.

Yet another illustrative embodiment of the invention is a method of granting permission to copy and reproduce content on a web server, wherein the method includes the steps of determining a scheme of rights for reproduction of content from a website; and setting one or more flags, accessible on the same website or another website, associated with the content, wherein each flag provides an authority level for copying and reproducing a portion or all of the associated content.

In particular, a first illustrative embodiment is a method of obtaining authority for copying content from a website accessible on an internet, comprising the steps of: (a) using the internet to identify content on a website and one or more flags associated with the content, wherein each flag provides an authority level for copying and subsequent reproduction of a portion or all of the associated content; and (b) copying content from the website in accordance with the authority level of the one or more flags.

A second illustrative embodiment, modifying the first embodiment, further comprises transmission of the copied content to a search engine database.

In a third illustrative embodiment, modifying the second embodiment, step (a) further comprises searching performed by a web crawler of a search engine, wherein the search engine comprises the web crawler and the search engine database.

In a fourth illustrative embodiment, modifying the first embodiment, said content on the website comprises one or more items selected from the group consisting of text file data, image file data, video file data, and audio file data.

In a fifth illustrative embodiment, modifying the fourth embodiment, wherein said authority level is different as between two or more types of content.

In a sixth illustrative embodiment, modifying the first embodiment, a plurality of users set the authority levels of the one or more flags.

In a seventh illustrative embodiment, modifying the first embodiment, said authority level is different as between two or more search engines.

An eighth illustrative embodiment comprises a system for obtaining authority to copy content from a website accessible on an internet, comprising: (a) one or more websites operably connected via an internet, wherein each computer website comprises content and one or more flags associated with the content, wherein each flag provides an authority level for copying a portion or all of the associated content; (b) a database operably connected to receive transmissions from the internet; and (c) a web crawler configured to operate via the internet to search the one or more websites to identify the one or more flags, wherein when the web crawler identifies one or more of the flags, the web crawler copies content associated with the identified flag and sends the copied content to the first database via the internet, and the first database stores the copied content.

In a ninth illustrative embodiment, modifying the eighth embodiment, said content authorized for copying comprises one or more types selected from the group consisting of text file data, image file data, video file data, and audio file data.

A tenth illustrative embodiment comprises a method of granting permission to copy and reproduce content on a website, comprising the steps of: (a) determining a scheme of rights for reproduction of content from a website; and (b) setting one or more flags, accessible on the same website or another website, each flag associated with at least a portion of the content, wherein each flag provides an authority level for copying and reproducing at least a portion of the associated content.

In an eleventh illustrative embodiment, modifying the tenth embodiment, said content from a website comprises one or more types selected from the group consisting of text file data, image file data, video file data, and audio file data.

In an twelfth illustrative embodiment, modifying the eleventh embodiment, said authority level is different as between two or more types of said content.

In a thirteenth illustrative embodiment, modifying the tenth embodiment, a plurality of users can set the authority levels of the one or more flags.

In a fourteenth illustrative embodiment, modifying the tenth embodiment, aid authority level is different as between two or more search engines.

In a fifteenth illustrative embodiment, the first embodiment further comprises the step of reproducing at least a portion of said copied content.

A sixteenth illustrative embodiment is the method of the first illustrative embodiment, wherein at least one of the one or more flags includes licensing information, and the method further comprises the steps of: (c) in accordance with the authority level of the portion of associated content to be copied, taking a license for the right to copy and reproduce the portion of the associated content to be copied based on the licensing information of the flag; and (d) copying and/or reproducing the licensed portion of associated content from the website.

A seventeenth illustrative embodiment is the method of the sixteenth embodiment, wherein the licensing information comprises a licensing agreement, and the method further comprises the step of: (e) paying one or more licensing fees upon licensing the right to copy and reproduce the portion of associated content to be copied.

An eighteenth illustrative embodiment is the method of the seventeenth embodiment, wherein the one or more licensing fees are paid electronically and/or via the internet.

A nineteenth illustrative embodiment is the method of the tenth illustrative embodiment, wherein at least one of the one or more flags includes licensing information, and the method further comprises the steps of: in accordance with the authority level of the portion of associated content to be copied, granting a license for the right to copy and reproduce the portion of the associated content to be copies based on the licensing information of the flag.

A twentieth illustrative embodiment is the method of the nineteenth illustrative embodiment, wherein the licensing information comprises a licensing agreement, and the method further comprises the step of: (d) collecting one or more licensing fees upon licensing the right to copy and reproduce the portion of associated content to be copied.

### BRIEF DESCRIPTION OF THE DRAWING

FIG. 1 illustrates a schematic showing an exemplary arrangement according to the invention.

### DETAILED DESCRIPTION OF THE ILLUSTRATIVE EMBODIMENTS

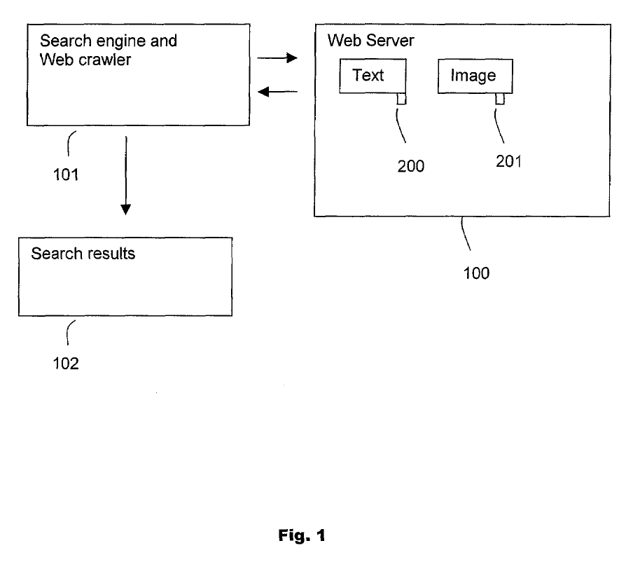

Referring now to FIG. 1, a web server 100 hosts on the internet various content including files containing text and other files that are image files. In this instance, the files having text are associated with a flag 200 whereas the image files are associated with a flag 201. The flag 200 permits excerpts of text in search results, whereas the flag 201 prohibits reproduction of image thumbnails in search results. The web crawler 101 accesses the server 100 including the text files and image files and their associated flags 200 and 201. On the basis of these flags, the search engine 101, in response to search engine queries, provides search results 102 in accordance with the flags: text excerpts are provided when appropriate, but image thumbnails are not.

Content can include text, including text formatted in any format (e.g., HTML, PDF, and word-processor documents); images; audio including music or other audio such as podcasts; and video including animation such as flash animation and animated interactive entertainment. Content may optionally be identified by MIME type.

Typically a website is hosted by a server. Multiple web sites can be served by the same server. Alternately, multiple servers may be involved in hosting a single web site.

A flag according to the present invention can be a portion of a conventional robots.txt data representation, or other data accessible on a web server, or the presence or absence of expected data. It may be a conventional file or may be dynamically generated. The flag may exist on a server other than the server containing the content described by the flag. The flag and the content may be on the same server, or they may be on different servers. Flags corresponding to various content on different servers may be collected at a separate, centralized source that serves as a clearinghouse. The flags may be part of otherwise conventional robots.txt representation, or may exist separately from any such representation.

The flags, in particular the authority level represented by the flags, preferably contain detailed information relating to authority for copying and/or republication of content from the source server especially by search engines or online archives or mirrors. The information most preferably describes source URIs (Uniform Resource Identifiers) and/or paths on the source server (even specific files) and how content from each such source and/or path may be republished, for example permitting or denying thumbnail republication of images, and likewise excerpts of text. There may be particular rules for particular MIME (Multipart Internet Mail Extension) types. The information in the flag may further describe limits on thumbnail size and size of text excerpts, such as when they are to be reproduced in search results. The information may limit republication to a subset of the content of a file: for example for an HTML (Hypertext Markup Language) file (including dynamic HTML), only text and not the formatting information, or length of text excerpts, or for an image file, specifically including or excluding header information such as EXIF (Exchangeable Image File) information. The information may further describe limits on the time a search engine may keep cached content for republication. Still further, the information in the flag can describe whether the content may be republished on the web in a frame.

Yet further, the information in a flag may describe copyright ownership, which may be especially useful when, for example, the entity owning the copyright on the content is not the same entity responsible for setting the flag. Along these lines, the information may include licensing information permitting further reproduction under certain circumstances. Such licensing can be, for example, a Creative Commons license, a GNU license, and pass-through licenses. In the context of this invention, “licensing” may mean taking a license and/or giving a license, as is clear from the context.

The flag may describe multiple rules or conditions simultaneously.

A flag can also include payment information relating to a fee for reproduction of the content. The flag may further include information instructing a copying entity to perform certain actions such as informing a party that the copying has occurred, for example via a “trackback” or other communication, the copying entity may be required to add a certain watermark to the content. The rules may further describe conditions for copying, such as the placement of an identifying mark or text in the copied file.

The flag may refer to an extraneous source of information, rules, etc., for example a hosted on the same or another website. In this way, more detailed rules and information may exist apart from the flag, and these may be updated and accessed separately from the flag. For example, although it is possible for a flag to contain terms relating consequences of exceeding the authority allowed by the flag-setting entity, such terms may be lengthy and better stored apart from the flag itself.

A flag is preferably a portion of a file text file readable by a human using a conventional text file viewer, however it may also be a representation on a server that is not easily read in this way (e.g., a binary file and/or dynamically-generated file). A flag may be encrypted. In some instances, the flag may even be embedded with a content file itself.

The invention also includes a method of granting permission to reproduce content on a web server. In this method, there is a determination of a scheme of rights for reproduction. This determination of a scheme can refer simply to the right with regard to one category or even one piece of content, but may also refer to a broad range of categories.

The invention further includes an embodiment wherein various users on a system can control flags. These user rights may relate to files under control of the particular user, or may be organized in a variety of other ways. For example, one user may control rights over video files on the system.

While the present invention has been described with reference to certain illustrative embodiments, one of ordinary skill in the art will recognize, that additions, deletions, substitutions, and improvements can be made while remaining within the scope and spirit of the invention as defined by the appended claims.

What is claimed is:

1. A method of obtaining authority for copying content from a website accessible on an internet, comprising the steps of:
(a) using the internet to identify content on a website and one or more flags associated with the content, wherein each flag provides an authority level for copying and subsequent reproduction of a portion or all of the associated content; and
(b) copying content from the website in accordance with the authority level of the one or more flags.

2. The method as recited by claim 1, further comprising transmission of the copied content to a search engine database.

3. The method as recited by claim 2, wherein step (a) further comprises searching performed by a web crawler of a search engine, wherein the search engine comprises the web crawler and the search engine database.

4. The method as recited by claim 1, wherein said content on the website comprises one or more types selected from the group consisting of text file data, image file data, video file data, and audio file data.

5. The method as recited by claim 4, wherein said authority level is different as between two or more types of content.

6. The method as recited by claim 1, wherein a plurality of users set the authority levels of the one or more flags.

7. The method as recited by claim 1, wherein said authority level is different as between two or more search engines.

8. A system for obtaining authority to copy content from a website accessible on an internet, comprising:
(a) one or more websites operably connected via an internet, wherein each computer website comprises content and one or more flags associated with the content, wherein each flag provides an authority level for copying a portion or all of the associated content;
(b) a database operably connected to receive transmissions from the internet; and
(c) a web crawler configured to operate via the internet to search the one or more websites to identify the one or more flags, wherein when the web crawler identifies one or more of the flags, the web crawler copies content associated with the identified flag and sends the copied content to the first database via the internet, and the first database stores the copied content.

9. A system as recited in claim 8, wherein said content authorized for copying comprises one or more types selected from the group consisting of text file data, image file data, video file data, and audio file data.

10. A method of granting permission to copy and reproduce content on a website, comprising the steps of:
(a) determining a scheme of rights for reproduction of content from a website; and
(b) setting one or more flags, accessible on the same website or another website, each flag associated with at least a portion of the content, wherein each flag provides an authority level for copying and reproducing at least a portion of the associated content.

11. The method as recited by claim 10, wherein said content from a website comprises one or more types selected from the group consisting of text file data, image file data, video file data, and audio file data.

12. The method as recited by claim 11, wherein said authority level is different as between two or more types of said content.

13. The method as recited by claim 10, wherein a plurality of users can set the authority levels of the one or more flags.

14. The method as recited by claim 10, wherein said authority level is different as between two or more search engines.

15. The method as recited by claim 1, further comprising the step of reproducing at least a portion of said copied content.

16. The method as recited by claim 1, wherein at least one of the one or more flags includes licensing information, and the method further comprises the steps of:
(c) in accordance with the authority level of the portion of associated content to be copied, taking a license for the right to copy and reproduce the portion of the associated content to be copied based on the licensing information of the flag; and
(d) copying and/or reproducing the licensed portion of associated content from the website.

17. The method as recited by claim 16, wherein the licensing information comprises a licensing agreement, and the method further comprises the step of:
(e) paying one or more licensing fees upon licensing the right to copy and reproduce the portion of associated content to be copied.

18. The method as recited by claim 17, wherein the one or more licensing fees are paid electronically and/or via the internet.

19. The method as recited by claim 10, wherein at least one of the one or more flags includes licensing information, and the method further comprises the steps of:
(c) in accordance with the authority level of the portion of associated content to be copied, granting a license for the right to copy and reproduce the portion of the associated content to be copies based on the licensing information of the flag.

20. The method as recited by claim 19, wherein the licensing information comprises a licensing agreement, and the method further comprises the step of:
(d) collecting one or more licensing fees upon licensing the right to copy and reproduce the portion of associated content to be copied.
